(19) United States
(12) Patent Application Publication
(10) Pub. No.: US 2008/0275868 A1
(43) Pub. Date: Nov. 6, 2008

(54) Graphic User Interface for the Construction of Complex Search Queries

(76) Inventor: Yoram Zer, Givataym (IL)

Correspondence Address: Yoram Zer, 5/9 Poalei Harakevet St., Givataym, 53254, IL

(21) Appl. No.: 12/113,240

(22) Filed: May 1, 2008

Related U.S. Application Data
(60) Provisional application No. 60/924,175, filed on May 2, 2007.

(51) Int. Cl. G06F 17/30; G06F 7/06

(52) U.S. Cl. 707/5; 707/E17.076; 707/E17.118

(57) ABSTRACT

A web application and a method for creating complex query strings for conducting searches in through at least one database comprising structured documents that are structured in content-fields.

The application comprises a GUI with an interactive table enabling users to insert search words, where the user can define the relations between at least some of the search words by the words in the interactive table. The searches through the structured documents' database may be conducted according to the search words and he relations between them.

Additionally, the application may allow the user to associate content-fields with at least some of the search words and conduct the searches in the content-fields defined for each search word.

### CROSS REFERENCE TO RELATED APPLICATION

This application claims the benefit of U.S. Provisional Patent Application 60/924,175 filed on May 2, 2007, which is incorporated herein by reference.

### FIELD OF THE INVENTION

The present invention relates to tools for aiding users to perform searches in large-scale databases; more particularly the present invention relates to tools, which aid users to construct complex queries for searching information reservoirs of structured data.

### BACKGROUND OF THE INVENTION

Performing searches in reservoirs of structured documents demands composing highly specific search queries. Known in the art are tools which provide users with the ability to structure highly specific complex search queries. Currently, professional search engines provide such tools; for instance, these search engines provide users with the ability to use nested Boolean operators and proximity operators, define the weight which expresses the relative importance of the search words and search for search words in specific segments of the document. Such professional search engines are prevalent in the fields of patents, academic documents, law documents and the like. The source database of professional search engines includes structured documents divided into several fields. For example, patent documents usually include an abstract, description, background and claims. Searches in these types of database may be performed according to the defined search fields. In addition, such source databases includes index of classification according to different topics and it is possible to improve the search using this classification.

There is therefore a need for a tool, which can facilitate the query building procedure for users searching for documents in large-scale structured databases.

### SUMMARY OF THE INVENTION

The present invention, in some embodiments thereof, discloses a query builder, which is an innovative tool for automatic creation of queries for complex searching through databases of structured documents, in accordance with user instructions.

The structured documents may be. For example, patent and patent-application content documents and drawings documents or articles documents that are structured into predefined content-fields, where each content-field contains content such as textual and/or graphical content.

According to an embodiment of the present invention the query builder may be implemented as a software application comprising a graphical user interface (GUI) for guiding users through the query building process.

According to some embodiments of the invention, the application may be a web application where said application comprising:
an interactive table of the search words, wherein the search words are organized according to priorities and relations between the search words, said table is programmed to enable the user to change search words priority and relation.
a software module for creating Boolean query string based on the search words inserted by a user into said interactive table;
   wherein said query is defined in accordance with the relations between the search words, wherein said relations are defined according to the organization of the search words within the interactive table.

According to some embodiments of the invention, the application may further enable the user to associate a content-field with at least one of the search words in the interactive table, wherein the search according to said query is carried out according to the content-fields associated with each search word of said query.

According to some embodiments of the invention, the web application may be operatively associated with at least one dictionary database, wherein the interactive table enables the user to add relevant search words from said dictionary database. Additionally, each search word of the interactive table may be a hyperlink, enabling the user open an interactive dictionary application that enables associating with said at least one dictionary database and select words to be included in the interactive table.

According to some embodiments of the invention, the application may further comprise a query scope module enabling to determine relevant categories for the query, wherein the determined queries are included within the Boolean query.

According to some embodiments of the invention, the web application may further comprise or be associated with at least one queries database enabling the user to save queries data and relevant search results in said queries database and to retrieve saved queries and search results from said queries database. Each query data record may comprise at least some of: search words, relevant classification, relevant search results and all search words inserted by the user during each saving of said query, wherein the structure of said queries database enables saving of a query search session comprising aggregated information of associated queries and query history having a common search scope.

According to some embodiments of the invention, the application may allow the user to save and display of at least one query-configuration, which is one of the recorded query data combination.

According to some embodiments of the invention, the application may further comprise a classification module enabling to receive at least one relevant classification of selected search results relating the created Boolean query and include said relevant classification within said Boolean query.

According to some embodiments of the invention, the application may enable creating different queries from one set of instructions provided by the user, wherein each of these queries optionally contains a different set of search words, wherein different proximity operators enable to locate and display proximate related words allowing different search content-fields to be chosen. Therefore, the application may enable creating a set of queries for the same search and comparing the number of results each query retrieves allowing users to define the number of desirable results, whereby the application determines which of the queries are most suitable.

According to some embodiments of the invention, the application may further comprise a communication module enabling to transmit query data to at least one second user.

According to some embodiments of the invention, the application may further comprise a type module enabling the user to associate an invention type to the query and allow searching for structured documents according to the type.

The process or method disclosed in some embodiments of the invention, may comprise at least some of the:
inserting search data which includes search words, and defining relation between said search words and properties of the search words;
creating a search query according to said search data by defining Boolean and proximity operators in accordance with defined relation, defining weights for each search word or group of search words according to search words properties and defining search content-fields for each search word or group of search words according to search words properties;
selecting at least one search type of the structured document;
associating an invention type to the query to allow searching for structured documents according to said selected type;
associating at least one content-field to at least one of the inserted search words, wherein said content-field defines the segment of content in the structured documents that is searched through for the associated search word;
defining search words' priorities, wherein each content-field is associated with a priority enabling to prioritize the presentation of search results according to the content-fields priorities; and
saving the created query within a queries database, wherein said queries database is organized according to relevant categories and the search words.

According to some embodiments of the invention, the query builder method for automatic creation of a query string and conducting searches in at least one structured documents' database, may additionally or alternatively comprise:
selecting root search words, wherein a user selects the search words;
defining the query search range by defining priority of each root search word;
defining query scope by determining the relevant content-fields;
creating Boolean query string based on integration of defined query context and scope.

### BRIEF DESCRIPTION OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein

FIG. 1 is a block diagram illustrating a software application for creating queries for searched through structured databases, according to some embodiments of the invention;

FIG. 2 is a flowchart illustrating the operative procedure according to some embodiments of the present invention;

FIG. 3 is a screen illustrating a graphical user interface of the application, according to some embodiments of the present invention;

FIG. 4 is a screen illustrating the query classification representation, according to some embodiments of the present invention;

FIG. 5 is a screen illustrating the query search results representation, according to some embodiments of the present invention; and

FIG. 6 schematically illustrates a process for creating a search query and operating of searches of structured documents, according to some embodiments of the invention.

The drawings together with the description make apparent to those skilled in the art how the invention may be embodied in practice.

No attempt is made to show structural details of the invention in more detail than is necessary for a fundamental understanding of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF SOME EMBODIMENTS OF THE INVENTION

The present invention, in some embodiments thereof, discloses a query builder, which is an innovative tool for automatic creation of queries for complex searching through databases of structured documents, in accordance with user instructions.

According to an embodiment of the present invention the query builder may be implemented as a software application 500 comprising a graphic user interface (GUI) for guiding users through the query building process.

For the purpose of this document the query building is described as operating in relation to patent search, however, the scope of the present invention should in no way be understood as applying only to searching in patent databases. The query-building tool may be incorporated into any type of tool, which is designed to facilitate searching in medium-scale to large-scale reservoirs of structured data.

On a broader scale, the proposed query-building tool may be integrated or incorporated into any other type of search engine, such as internet search engines.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions. It is understood that the phraseology and terminology employed herein is not to be construed as limiting and are for descriptive purpose only.

The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers. The phrase “consisting essentially of”, and grammatical variants thereof, when used herein is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks. The term “method” refers to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined. The present invention can be implemented in the testing or practice with methods and materials equivalent or similar to those described herein.

The terms “bottom”, “below”, “top” and “above” as used herein do not necessarily indicate that a “bottom” component is below a “top” component, or that a component that is “below” is indeed “below” another component or that a component that is “above” is indeed “above” another component. As such, directions, components or both may be flipped, rotated, moved in space, placed in a diagonal orientation or position, placed horizontally or vertically, or similarly modified. Accordingly, it will be appreciated that the terms “bottom”, “below”, “top” and “above” may be used herein for exemplary purposes only, to illustrate the relative positioning or placement of certain components, to indicate a first and a second component or to do both.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

The purpose of the present invention is to provide a tool for automatic phrasing of search queries for facilitating searches through source databases of structured documents. The structured documents (e.g. patent and patent application documents) are usually divided into several fields and may be associated with one or more classifications.

For example, patent documents usually include at least some of the fields of abstract, description, background and claims. Searches in these types of databases may be performed according to the defined search fields. For example, the search may be of search words in the Abstract field and/or the summary field and the like. In addition, such source databases may include index of classification of the patent documents according to different topics/categories and it may be possible to improve and refine the search using this classification. For example, the index topics may be “electrical appliances”, Software Applications” and the like, facilitating the user in searching for search words in selected fields that are also related to (in the database) a specific classification.

The syntax of the query may be constructed according to selections and instructions of the user, including the relevant search terms (referred to hereinafter as “search words”) and operators.

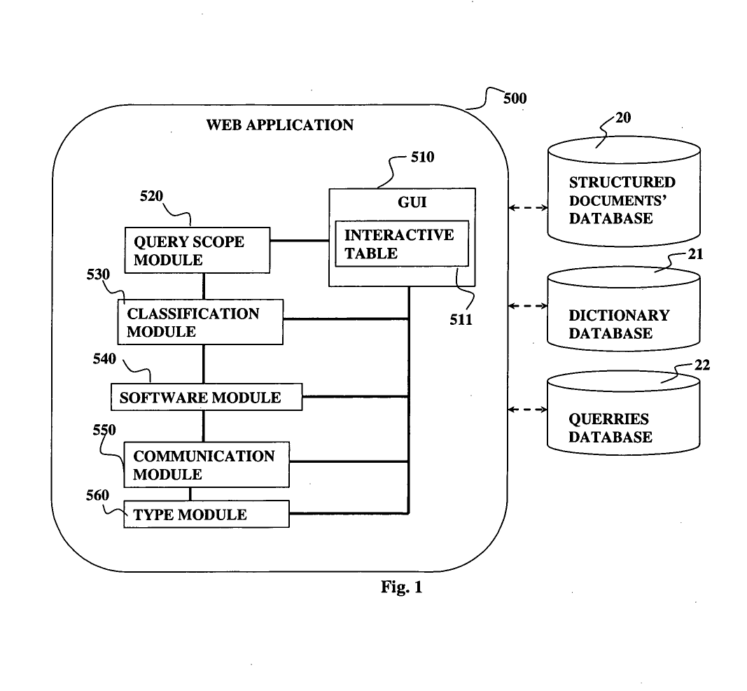

FIG. 1 is a block diagram schematically illustrating a software application 500, which may be a web application 500, for creating query strings for conducting searches in on or more search engines of at least one of a technological or a scientific structured documents' database 20, according to some embodiments of the invention. According to these embodiments, the application 500 may comprise at least some of:
a graphical user interface (GUI) 510;
a software module 540;
a communication module 550;
a classification module 530;
a query scope module 550; and
a type module 560.

According to some embodiments of the invention, the GUI 510 and at least some of the modules 520-550 may be operatively associated with one another.

According to some embodiments of the invention, the GUI 510 may comprise an interactive table 511 enabling the user to input search words and present the search words and other aspects related to those search words in a table. Additionally, the search words may be organized according to priorities and relations between the search words, where the interactive table 511 may be programmed to enable the user to change and/or define search words priority and relation.

According to some embodiments of the invention, the interactive table 511 may be a hyperlink, enabling the user open an interactive dictionary application and select words to be included in the interactive table 511.

According to some embodiments of the invention, the application 500 may enable communicating, retrieval and updating of data of at least one of: (i) the structured documents' database 20, (ii) one or more dictionary databases 21, which may also include thesauruses, and (iii) queries database 22.

The structured documents' database 20 may include technical/scientific structured data sheets (or documents) such as patent documents (structured into content-fields and classified according to predefined classes); law documents; articles and the like.

Each structured document may be saved in the structured documents' databases 20 according to predefined structures such as content-fields, as known in the art. For example, a patent document is usually structured in content-fields (e.g. Drawings, Field of the invention, summary of the invention, description of the drawings, detailed description of the invention and claims). Each document may also be associated with one ore more classes and categories to allow refining the searches in the structured documents' database 20. The content-field may define the segment of content in the structured documents that will be searched through for the associated search word.

The dictionary database 21 may include words or textual terms and their synonyms, thesauruses and the like in at least one language. The dictionary database 21 may enable the user to add relevant search words, find synonyms and other relevant search words that can be added to the table 511 and save theses search words in the dictionary database 21.

The queries database 22 may enable the user to save queries data and relevant search results such as the, for example, the code (e.g. HTML code) of the structured documents of the search results and the document's structure data (e.g. content-fields and classifications).

According to some embodiments of the invention, the software module 540 may enable creating Boolean query strings based on the search words appearing within the interactive table 511. One or more Boolean operators may be defined in accordance with the priority and relation between the search words based on the organization of the search words within the interactive table 530.

According to some embodiments of the invention, the query scope module 520 may enable the user to determine relevant categories (e.g. technical groups) to be included in the query. The technical group, once associated with a search word may define a specific set of related search word taken from a dictionary database 21, which may be associated with the defined technical group. For example, the word “surf” when associated with a technical group “Software” means surfing the web and may result in related words from the software vocabulary.

According to some embodiments of the invention, the query scope module 520 and the structure of the queries database 22 may enable saving each query data record as “query session” comprising at least some of: search words, relevant classification, relevant search results and all search words inserted by the user during each saving of said query. The structure of the queries database 22 may enable saving of the query search session comprising aggregated information of associated queries and query history having a common search scope.

For example, if the user has inserted temporary search words that were eventually removed from the query, this data may still be recorded by the application 500 in the session. Additionally, the session may enable separating the user's final query from other related information saved in the session and enable the user to use this other information data when retrieving the saved query session.

According to some embodiments of the invention, the application 500 may further allow the user to save and display of at least one query-configuration, which is one of the recorded query data combination, comprising the search words and other related data (e.g. classification) of, for example, one of the query configurations the user have tried and wishes to save for later review (e.g. the configuration that yielded the most relevant or best search results).

According to some embodiments of the invention, the classification module 530 may enable receiving at least one relevant classification of selected search results relating the created Boolean query and include said relevant classification within the Boolean query. For example, once the search results of a first query are presented the GUI 510 may enable the user to select a class (which relates to the field of the invention e.g. electric appliances/software web application/gardening tools etc.) thereby to associate this selected class to the query and re-present only the resulting patents/applications that are also associated to the same class.

According to some embodiments of the invention, the communication module 550 may enable transmitting all query data (e.g. search words, the relations between the search words, classes, categories and associated content-fields) to one ore more second users and/or to a main web server (not shown) enabling a multiplicity of users to share query information and to build and develop a queries database 22 (see FIG. 1).

According to some embodiments of the present invention, the application 500 may be implemented as a web application 500, enabling the user to access the wizard through a data network application. The user may use the wizard as anonymous user for creating queries and conduct searches. Optionally the user may register to the web application 500, enabling the user to save queries and search results for future use. The queries and search results may be saved in a central server (not shown), providing users with login access to previously saved queries and search results.

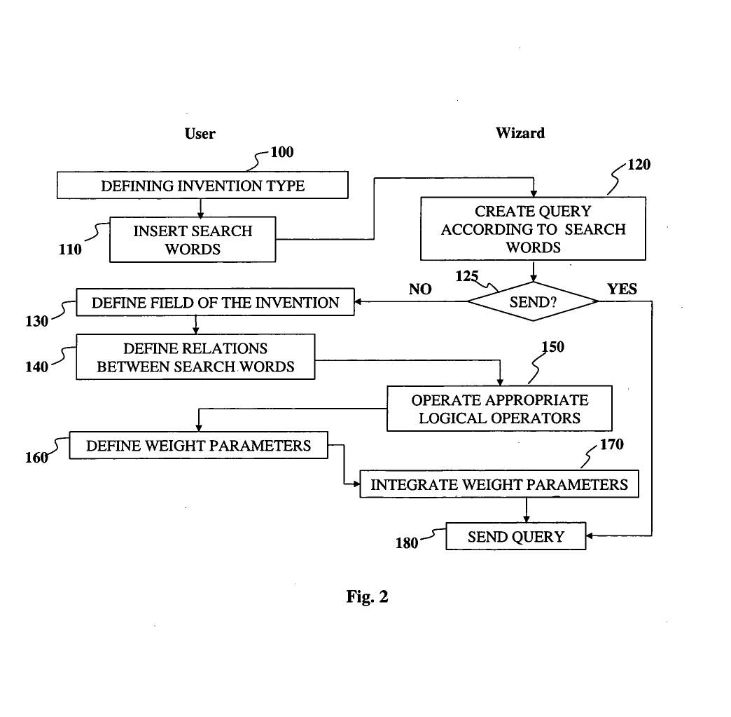

FIG. 2 is a flowchart illustrating the operative procedure according to an embodiment of the present invention.

First, the user defines the type of the structured document content (step 100) he/she wishes to find (e.g. the type of the invention, where the structured document search relates to patent documents disclosing inventions).

The proposed embodiments may also include a queries database 22 for storing the history of queries and search results created by each user through the application 500. In this database the search results may be saved and indexed in accordance with the created queries, the field of invention, and the search words the user defined in each part of the process. This queries database 22 may be queried by searching for correlations between user new search definitions and indexed recorded search results. The user may further define when the search is successful and mark the relevant patents. The records may be saved as private collections of specific clients or organizations, accessed only for the authorized users, or as public database serving all inventors enabling to shortcut the search process for search topics already previously searched. The queries records may also include for each word the meaning of the word as selected by the user during the process of finding related as described above. Such information may be valuable for classifying the queries and determining the context of the search.

According to some embodiments of the invention, the type module 560 may enable the user to associate a type to the invention and allow searching for structured documents according to the selected type.

In case the structured documents, through which the searches are conducted, are patent documents disclosing inventions, the users may, for instance, define the invention type out of predefined types, which may be, for example at least some of: (i) an invention, which is an integration of different known technologies (“Integration Type”); (ii) an invention, which is a new solution to a known problem (“Solution Type”); and (iii) an invention, which discloses a specific mode of a known solution (e.g. using a known technology for a specific application) (“Specific Mode Type”).

The selected type may enable the user to input data that is related to the specific type and carry out the search accordingly. For example, if the user has selected the “Integration Type” which means that the invention is an integration of two or more technology fields than the GUI 510 may automatically display an interface that allows the user to input the fields of the invention. For example an invention that combines a cellular phone with a flash light. The user may be enabled to insert search words relating to the field of cellular phones (e.g. mobile/wireless device etc.) in one table 511 and search words relating to flash lights (e.g. lighting device/torch/luminous etc.) in a second table 511 and search through all combinations of a search word from the first table 511 with all search words from the second table 511 (e.g. using an OR operator).

According to some embodiments, the users may define the requested invention type as a combination of several types, such as an invention, which may be both a Solution Type and a Specific Mode Type, etc.

According to some embodiments of the invention, the application 500 may enable the user to (i) define at least two groups of root search words (e.g. by inserting search words into at least two tables each table is associated with a predefined group); and to (ii) create a multiplicity of Boolean query strings, where each string includes one possible combination of at least one word from said at least two groups. For example, the user inserts two root search words in each of two predefined groups: search word 1 and search word 2 in group I and search word 3 and search word 4 in group II. The application 500 may produce four query strings including:

search word 1 with search word 3;

search word 1 with search word 4;

search word 2 with search word 3;

search word 2 with search word 4.

For each type defined by the user, the user may be required to define the relevant search words for each component or technology type (step 110).

In accordance with user definitions, the query builder wizard application 500 may create queries including operators that enable the user to define relations between at least some of the search words. For example, operators creating AND or OR relations between the different groups of search words, each of those groups may optionally include one ore more search words (step 120).

The user may further be required to define the relevant field of invention (class) (step 130). Provided that each group of search words relates to different aspects of the invention of the structured document, the user may select a different invention field to each group of search words. The fields may be predefined allowing the user to associate at least one of the classes with each group of words.

If, for example, the invention combines the topics of cellular phone technology and medicine treatment, the user may define the field of invention for each of these topics. The field of invention is defined according to a predefined list of topics. These user definitions may then be used by a query builder wizard to refine the search query by limiting the results to specific predefined classes as provided by the patent documents data sources such as the United States Patent and Trademark Office (USPTO) or the International Patent Classification (IPC).

At the next step, the user may be required to define the relations between the selected search words (step 140). For instance, the user may define the relations between particular search words as synonyms or complementary words associated with one or more root search words. The query builder wizard application 500 may define OR operators for synonyms and proximity operators for commentary words (step 150). Furthermore, the user can define the importance of each search word by setting a weight parameter for each word (step 160). The weight parameter may be taken into account by the application 500 in at least one of several ways (step 170). For instance, the application 500 may choose the relevant search content-fields in accordance with the weights defined for each word. For example, when building a query for searching in patent databases essential words should be searched for in the abstract or claims segments of the patent documents, where the segments are predefined content-fields according to which each structured document is segmented in the database. Additionally, the weight parameters may be used to define the number of occurrences of the particular word or word combination in the searched documents. For example, the application 500 may be programmed to search for a predefined number of occurrences of a search word, which is defined as essential. The relevant content-fields may optionally be selected in accordance with a relevant guiding question. For example, a question may relate to the problem the invention is aimed to solve, and the search words, which the user defines, are then searched for in the background segment of the document.

According to an embodiment of the present invention, the application 500 may create different queries from one set of instructions provided by the user. Each of these queries optionally contains a different set of search words, different proximity operators can be defined enabling to locate and display proximate related words such as exact phrases (synonym) or near by words, and different search content-fields may optionally be chosen.

Thus, according to this embodiment, the application 500 may enable creating a set of queries for the same search and comparing the number of results each query retrieves. Users can then define the number of desirable results; according to this criterion the application 500 can determine which of the queries are most suitable.

According to an additional embodiment of the present invention, the query may be programmed in such a manner that allows automatically changing the structure of the query according to the number of retrieved results. For instance, provided that a query which includes the exact phrase operator retrieves only a very small number of results, the query may be changed by the application 500 to include the operator near by instead of the exact phrase operator. According to an additional embodiment of the present invention the application 500 can further compare the list of search results and provide the user with a unified search results report eliminating duplicate results.

According to an embodiment of the present invention a thesaurus may be integrated into the application 500. The thesaurus provides the user with relevant synonyms and related, complementary search words in accordance with the defined search topic. Additionally, the thesaurus may present the user different meanings of the same word and enable the user to choose the relevant meaning. Provided that the user selects the relevant meaning of a search word the synonymy which the system provides to the user may include only words which are relevant to the specific meaning of the search word which the user selected.

Additionally, the thesaurus may present the user only with words whose meanings are relevant in accordance with the search topic defined by the user at the beginning of the process. Using the wizard the user can select any of the words in the synonymy and the system includes the selected words appropriately in the queries.

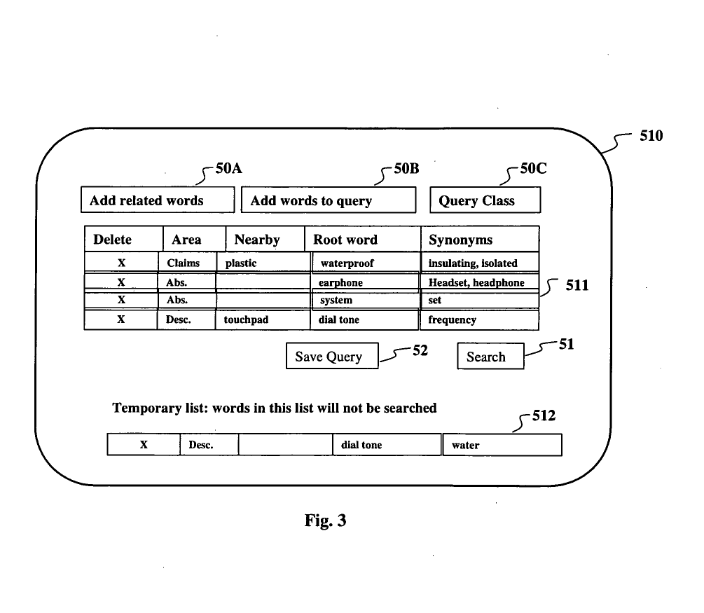

FIG. 3 schematically illustrates the interactive table 511 of the GUI 510. The interactive table 511 may comprise columns allowing the user to define root search words, the content-field(s) associated with that root search word and to find nearby and/or synonyms related search words using the dictionaries and the thesauruses. The GUI 510 may allow the user to define additional features of the query such as to: add related search words 50A to the query, add new root search words 50B, and define query class 50C etc.

Once the user has defined the root and related search words and other features of the query, the GUI 510 may enable the user to save the query by pressing a virtual save button 52 and/or to operate the search according to the created query by pressing a virtual search button 51.

The temporary list of search words 512 may enable the user to decide to add at least some of the search words in the list to the actual query at a later stage. The words in the temporary list may be search words, which were used in previous versions of the search and are not currently used for a specific query. The user is enabled to drag and drop words between the main interactive table 511 of the search words and temporary words table 512.

According to some embodiments of the present invention, as illustrated in FIG. 3, the search words in the interactive table 511 may be organized within the table 511 in a manner that reflects the relation between the words and define the range of the search by assigning the query words priority e.g. at what section of the searched documents each word is searched. An example of such table interface is illustrated in FIG. 3. Each row of the table includes one original word and related words. The order of the rows reflects the priority of the words, each set of rows indicate the search content-fields. In this example the first set of row indicate the abstract search content-field, the second set of the rows indicates the claims search content-field, and the last set of rows indicates the description search content-field. The user is enabled to moves the words between rows, using drag and drop utility, hence changing the words priority. Each word in the table is a hyperlink which opens a thesaurus dictionary providing the user with related words organized according to words meaning. The user can select related words and add them to the query table, the words are added at same row of the original word.

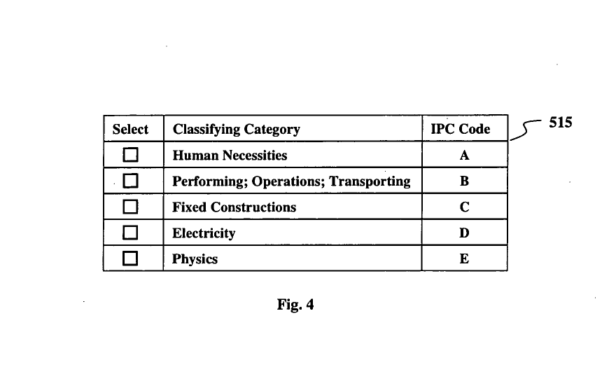

FIG. 4 schematically illustrates a classification table 515 enabling a user to define the class of the invention that may be associated with the query.

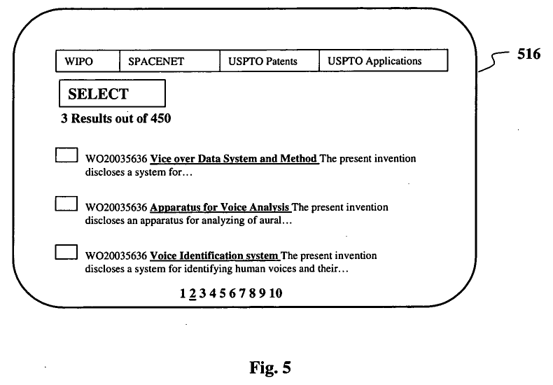

FIG. 5 schematically illustrates a presentation of search results 516 in the GUI 510 enabling the user to view all structured documents (e.g. patents/patent applications) that are associated with the user's query and to select save the selected results.

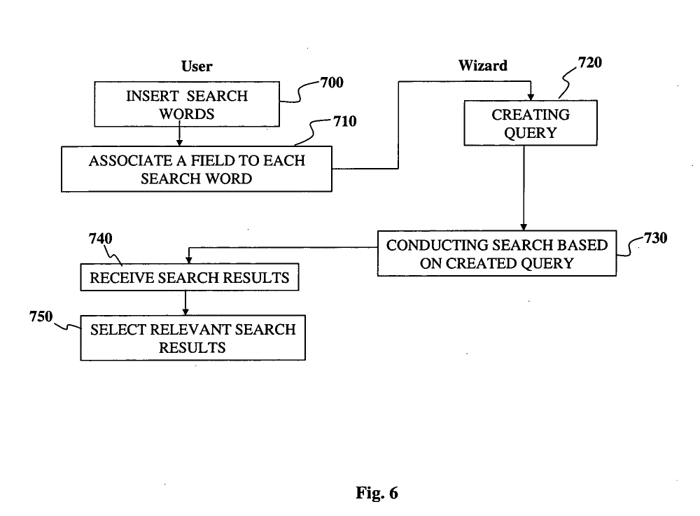

FIG. 6 schematically illustrates a process enabling a user to create a search query and to operate a search through at least one structured documents' databases 20 using the created query, according to some embodiments of the invention. The process may comprise:
inserting search words 700, where the user inserts the search words into the interactive table 511 by using the GUI 510;
associating a content-field to each search word 710, where the user may select a content-field which is defined by the structure of the documents and associate it to the word thereby;
creating a query according to the search words and associated content-fields arrangement 720;
conducting a search according to the created query 730;
receiving search results 740, where the results may be uploaded and presented through the GUI 510;
selecting relevant search results 750, where the user selects the results by using the GUI 510;

According to some embodiments of the invention, the application 500 may enable inserting search data which includes the search words, relation between the search words and properties of the search words (e.g. associating the search words with the content-fields and the like;

Additionally or alternatively, the application 500 may enable building a search query based upon the search data by defining Boolean and proximity operators in accordance with defined relation, defining weights for each search word or group of search words according to search words properties and defining search content-fields for each search word or group of search words according to search words properties.

According to some embodiments of the present invention, the user may add related search words which are defined as equivalent to the a certain word or idiom, the added words may be recorded in relation to the respective in personal dictionary of the user, or shared dictionary of community of users. According to the embodiment is created a database of dictionary of related words, which is based ongoing work of at least one in accordance with his needs or the community needs. This dictionary is activated each time the user seeks for related words. The added words may be related to specific meaning of the word and suggested only when the user uses the word in a specific meaning.

According to other embodiments of the present invention it is suggested to provide a table of selected structured documents (such as patent and patent applications documents), this table may be a list of all patents/application results selected by the user during the processing the search query. According to further options, the user may select to retrieve the classification of the results.

According to another embodiment of the present invention is provided a communication utility enabling a user of the application to transmit the query data including the search words and their relation, the classifications and the results through a communication network such as the Internet, optionally the query data can be transferred through e-mail communication. The user receiving the query data can proceed the search using all query data and may edit the query data according to with his search strategy.

While the invention has been described with respect to a limited number of embodiments, these should not be construed as limitations on the scope of the invention, but rather as exemplifications of some of the embodiments. Those skilled in the art will envision other possible variations, modifications, and applications that are also within the scope of the invention. Accordingly, the scope of the invention should not be limited by what has thus far been described, but by the appended claims and their legal equivalents. Therefore, it is to be understood that alternatives, modifications, and variations of the present invention are to be construed as being within the scope and spirit of the appended claims.

What is claimed is:

1. A web application for creating query string for conducting searches in at least one search engine of at least one database of structured documents structured according to content-fields, said application comprising:
an interactive table of the search words, wherein the search words are organized according to priorities and relations between the search words, said table is programmed to enable the user to change search words priority and relations; and
a software module for creating Boolean query string based on the search words inserted by a user into said interactive table,
wherein said query is defined in accordance with the relations between the search words, wherein said relations are defined according to the organization of the search words within the interactive table.

2. The web application of claim 1 further enables the user to associate a content-field with at least one of the search words in the interactive table, wherein the search according to said query is carried out according to the content-fields associated with each search word of said query.

3. The web application of claim 2 is operatively associated with at least one dictionary database wherein the interactive table enables the user to add relevant search words from said dictionary database,
wherein each search word of the interactive table is a hyperlink, enabling the user open an interactive dictionary application that enables associating with said at least one dictionary database and select words to be included in the interactive table.

4. The web application of claim 1 further comprising a query scope module enabling to determine relevant categories for the query, wherein the determined queries are included within the Boolean query.

5. The web application of claim 4 further comprising queries database enabling the user to save queries data and relevant search results in said queries database and to retrieve saved queries and search results from said queries database,
wherein each query data record comprises at least some of: search words, relevant classification, relevant search results and all search words inserted by the user during each saving of said query, wherein the structure of said queries database enables saving of a query search session comprising aggregated information of associated queries and query history having a common search scope.

6. The web application of claim 5 further allows a user to save and display of at least one query-configuration, which is one of the recorded query data combinations.

7. The web application of claim 1, wherein each document is associated with at least one classification and wherein said application further comprises a classification module enabling to receive at least one relevant classification of selected search results relating the created Boolean query and include said relevant classification within said Boolean query.

8. The web application of claim 1 creates different queries from one set of instructions provided by the user, wherein each of these queries optionally contains a different set of search words,
wherein different proximity operators enable to locate and display proximate related words allowing different search content-fields to be chosen;
thus, the application enables creating a set of queries for the same search and comparing the number of results each query retrieves, allowing users to define the number of desirable results, whereby the application determines which of the queries are most suitable.

9. The web application of claim 1 further comprising a communication module enabling to transmit query data to at least one second user.

10. The web application of claim 1 further comprising a type module enabling the user to associate an invention type to the query and allow searching for structured documents according to the type.

11. The web application of claim 1 wherein said structured documents are one of: patent and patent-application content documents or articles documents, wherein said documents are structured into predefined content-fields.

12. A query builder method for automatic creation of a query string for conducting a search through at least one database of structured documents structured according to content-fields, said method comprising:
inserting search data which includes search words, and defining relation between said search words and properties of the search words;
creating a search query according to said search data by defining Boolean and proximity operators in accordance with defined relation, defining weights for each search word or group of search words according to search words properties and defining search content-fields for each search word or group of search words according to search words properties.

13. The method of claim 12 further comprising the steps of:
selecting at least one invention type of the structured document; and
associating an invention type to the query to allow searching for structured documents according to said selected type.

14. The method of claim 12 further comprising the step of associating at least one content-field to at least one of the inserted search words, wherein said content-field defines the segment of content in the structured documents that is searched through for the associated search word.

15. The method of claim 12 further comprising defining search words' priorities, wherein each content-field is associated with a priority enabling to prioritize the presentation of search results according to the content-fields priorities.

16. The method of claim 12 further comprising the step of saving the created query within a queries database, wherein said queries database is organized according to relevant categories and the search words.

17. The method of claim 12 further comprising the steps of:
defining root search words, wherein a user selects the search words;
defining the query search range by defining priority of each root search word;
defining query scope by determining the relevant content-fields;
creating at least one Boolean query string based on integration of defined query context and scope.

18. A query builder method for automatic creation of a query string for conducting searches in a search engine of at least one database of structured documents structured according to content-fields, said method comprising the steps of:
defining at least two groups of root search words;
creating a multiplicity of Boolean query strings, wherein each string includes one possible combination of at least one word from said at least two groups.

19. The method of claim 18 further comprises the step of searching for relevant structured documents for each combination of search word and their associated content-fields, wherein each search word is associated with at least one content-field.
